(19) United States
(12) Patent Application Publication
(10) Pub. No.: US 2012/0051550 A1
(43) Pub. Date: Mar. 1, 2012

(54) SOUND RECORDING DEVICE, SOUND PLAYBACK DEVICE, AND SOUND RECORDING/PLAYBACK DEVICE

(75) Inventors: Tatsuo Koga, Osaka (JP); Yuji Yamamoto, Osaka (JP); Satoru Matsumoto, Osaka (JP); Hisatoshi Oomae, Osaka (JP)

(73) Assignee: SANYO ELECTRIC CO., LTD., Osaka (JP)

(21) Appl. No.: 13/265,797

(22) PCT Filed: Mar. 4, 2010
(86) PCT No.: PCT/JP2010/053514

§ 371 Date: Oct. 21, 2011

(30) Foreign Application Priority Data
Apr. 21, 2009 (JP) 2009-102693
Apr. 21, 2009 (JP) 2009-102694
Apr. 27, 2009 (JP) 2009-108268

(51) Int. Cl. H04R 29/00; H04R 3/00

(52) U.S. Cl. 381/56; 381/122

(57) ABSTRACT

Provided is a sound recording/playback device (1) that records onto a recording medium (5) sound data captured by a microphone (6), pulls the sound data from the recording medium (5), and plays said sound data. The sound recording/playback device is provided with a discrimination means (21, 22, 23, 24) which discriminates between human sound and non-sound audio. Upon recording, the device records the start position and end position of human sound, as determined by the discrimination means (21, 22, 23, 24), and upon playback, the data between the afore-mentioned start position and the subsequent end position is extracted and outputted.

### TECHNICAL FIELD

The present invention relates to a sound recording device for recording sound data on a recording medium. The invention also relates to a sound recording/playback device for recording sound on, and replaying sound from, a recording medium. The invention further relates to a sound playback device for replaying sound recorded on a recording medium.

### BACKGROUND ART

With conventional sound recording/playback devices such as sound recorders, when recording is started, human voice such as in conversation is recorded on a recording medium. Moreover, in response to a predetermined operation, sound data stored on a recording medium is retrieved and replayed.

### LIST OF CITATIONS

### Patent Literature

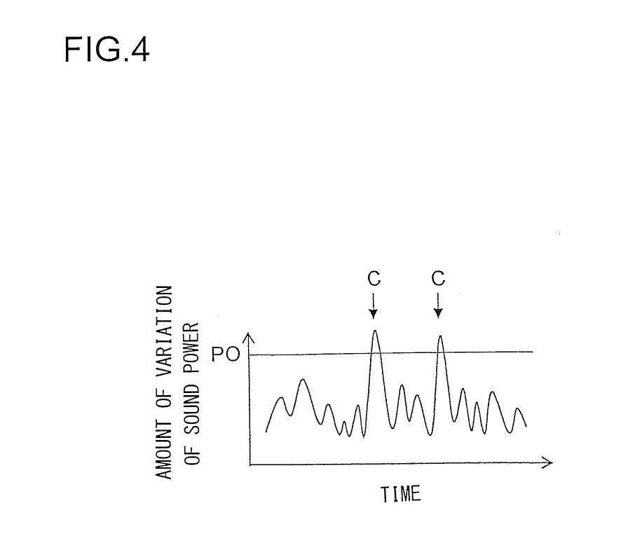

Patent Document 1: JP-A-H11-312394, pages 2-7, FIG. 4

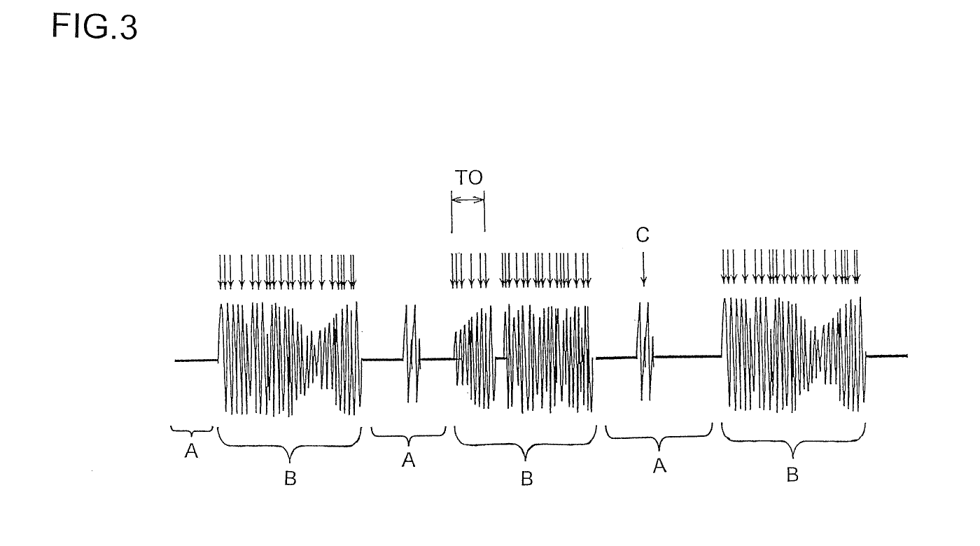

Patent Document 2: JP-A-2008-170789, pages 4-10, FIG. 3

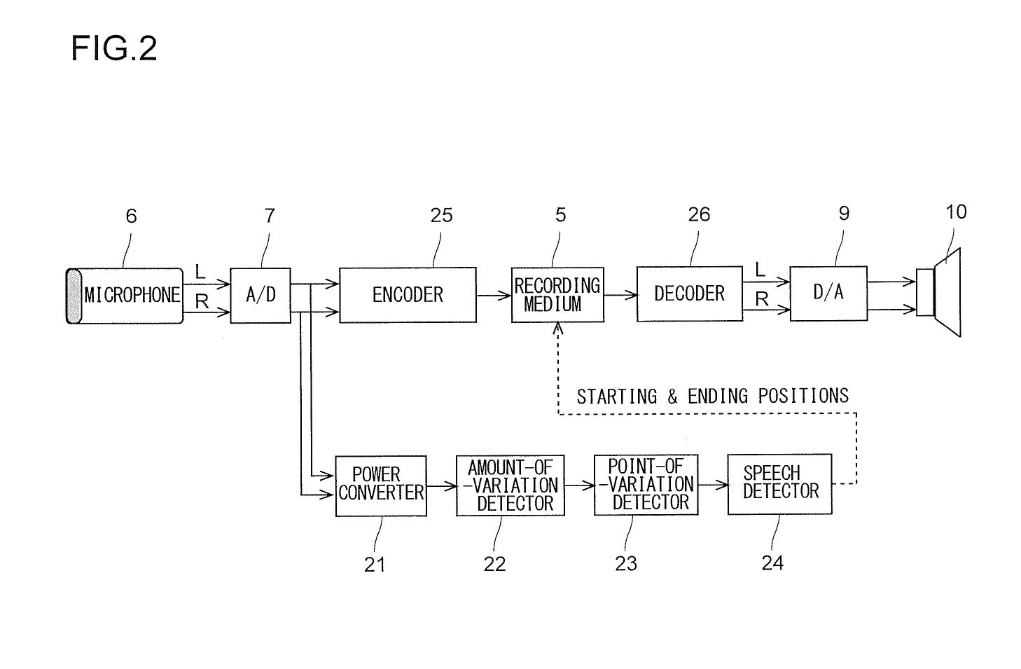

Patent Document 3: JP-A-2008-281850, pages 3-6, FIG. 2

Patent Document 4: JP-A-2006-50045, pages 4-12, FIG. 4

### SUMMARY OF INVENTION

### Technical Problem

Inconveniently, with the conventional sound recording/playback devices mentioned above, during recording, sound data of not only human voice, but also silence, noise (such as sound of a desk being pounded before a meeting and a chair being dragged), etc., that is, unnecessary sound data of other than human voice, is also recorded on a recording medium. As a result, during playback, the user needs to make complicated operations such as “fast forwarding” and “rewinding” to cut (skip) unnecessary intervals, and this spoils the usability of sound recording/playback devices. Similar inconveniences are experienced with sound playback devices for retrieving and replaying sound data recorded on a recording medium.

Patent Document 1 discloses a sound recording device that can cut silent intervals during recording of sound. With this sound recording device, when an instruction to start recording is entered, sound data obtained by a microphone is analyzed and, when the average energy of the sound exceeds a predetermined threshold, recording is started. This makes it possible to perform recoding while cutting silent intervals such as before a meeting, and thus helps eliminate unnecessary recording.

Inconveniently, however, with the sound recording device disclosed in Patent Document 1 mentioned above, recording is started even by noise such as sound of a desk being pounded or a chair being dragged, and this leads to unnecessary consumption of memory.

To overcome this inconvenience, Patent Document 2 discloses a sound recording device that starts recording on discriminating human voice. In this sound recording device, from sound data fed from a microphone, the average value of the power spectrum is derived at predetermined intervals. In silent intervals, the power spectrum is small and accordingly its average value is small; noise as mentioned above is momentary, and this makes the average value of the power spectrum small. Thus, it is possible to discriminate human voice from silence and noise. This makes it possible to start recording on recognizing human voice, and helps suppress unnecessary consumption of memory.

Inconveniently, however, in the sound recording/playback device disclosed in Patent Document 2 mentioned above, the sound data obtained by the microphone needs to be decomposed into different frequency components to acquire the power spectrum and derive the average value. Thus, discriminating human voice requires heavy processing, and the discriminating takes time. This causes recording to be started with delay, and spoils the usability of the sound recording device. Also inconveniently, a configuration in which the sound data during the period for discriminating human voice is stored on memory so that recording is started retroactively to the completion of recognizing human voice requires a large capacity of memory and thus incurs high cost.

An object of the present invention is to provide a sound recording/playback device and a sound playback device that offer improved usability during playback. Another object of the invention is to provide a sound recording device that can quickly discriminate human voice during recording of sound and that thereby achieves improved usability and reduced cost.

### Solution to Problem

To achieve the above objects, according to one embodiment of the invention, a sound recording/playback device which performs recording by recording sound data obtained by a microphone on a recording medium and which performs playback by retrieving sound data from the recording medium is provided with a discriminator which discriminates between human voice and other than human voice. Here, during recording, the starting position and the ending position of the human voice discriminated by the discriminator are recorded, and during playback, the interval between the starting position and the subsequent ending position is extracted and output.

With this configuration, when an operation to start recording is made, sound data obtained by the microphone is recorded on the recording medium. At this time, the discriminator discriminates, in the sound data, between a region of human voice and a region of other than human voice, and the starting position and ending position of each region of human voice are, along with the sound data, recorded on the recording medium. When an operation to start playback is made, sound data is retrieved from the recording medium, and playback is performed. At this time, first, the interval between the starting position and ending position of the first region of human voice is extracted and output, and subsequently the interval between the starting position and ending position of one after another of the second and following such regions are sequentially extracted and output.

According to another embodiment of the invention, a sound recording/playback device which performs recording by recording sound data obtained by a microphone on a recording medium and which performs playback by retrieving sound data from the recording medium is provided with a discriminator which discriminates between human voice and other than human voice. Here, during recording, the starting position of the human voice discriminated by the discriminator is recorded, and during playback, in response to a predetermined operation, a skip is made to the next starting position.

With this configuration, when an operation to start recording is made, sound data obtained by the microphone is recorded on the recording medium. At this time, the discriminator discriminates, in the sound data, between a region of human voice and a region of other than human voice, and the starting position of each region of human voice is, along with the sound data, recorded on the recording medium. When an operation to start playback is made, sound data is retrieved from the recording medium, and playback is performed. During playback, when a predetermined operation is made, a skip is made to the starting position of the next region of human voice, and this region is replayed.

According to one embodiment of the invention, in the sound recording/playback devices described above, the discriminator includes: an amount-of-variation detector which detects the amount of variation per unit time of sound power based on the sound data obtained by the microphone; and a point-of-variation detector which detects a point of variation at which the amount of variation is greater than a predetermined value. Here, when the number of points of variation detected within a predetermined discrimination period is greater than a predetermined number, it is judged that human voice is present.

With this configuration, the amount of variation per unit time of sound power based on the sound data obtained by the microphone is detected by the amount-of-variation detector. Whether or not the amount of variation is greater than a predetermined value is checked by the point-of-variation detector, and if it is, a point of variation is stored. The number of points of variation within a predetermined discrimination period is monitored so that, if the number is greater than a previously set predetermined number, it is judged that human voice is present and, if less, it is judged that noise or silence is present. In this way, the starting position and ending position of each region of human voice are detected.

According to another embodiment of the invention, in the sound recording/playback devices described above, the discriminator includes: an amount-of-variation detector which detects the amount of variation per unit time of sound power based on the sound data obtained by the microphone; and a point-of-variation detector which detects a point of variation at which the amount of variation is greater than a predetermined value. Here, when the point of variation is detected within a predetermined discrimination period, it is judged that human voice is present.

With this configuration, the amount of variation per unit time of sound power based on the sound data obtained by the microphone is detected by the amount-of-variation detector. Whether or not the amount of variation is greater than a predetermined value is checked by the point-of-variation detector, and if it is, a point of variation is stored. Whether or not a point of variation appears within a predetermined discrimination period is watched so that, when one does, it is judged that human voice is present and, otherwise, it is judged that noise or silence is present.

According to one embodiment of the invention, in the sound recording/playback devices described above, when the sound power is lower than a predetermined value, the point-of-variation detector does not detect a point of variation. With this configuration, whether or not the sound power of the sound data obtained by the microphone is lower than a predetermined value is checked. If the sound power is lower than the predetermined value, even when the amount of variation of the sound power is great, it is ignored with regard to the detection of a point of variation.

According to another embodiment of the invention, a sound playback device which performs playback of sound by retrieving sound data recorded on a recording medium is provided with a discriminator which discriminates between human voice and other than human voice. Here, the discriminator includes: an amount-of-variation detector which detects the amount of variation per unit time of sound power based on sound data; and a point-of-variation detector which detects a point of variation at which the amount of variation is greater than a predetermined value. Moreover, when the number of points of variation detected within a predetermined discrimination period is greater than a predetermined number, it is judged that human voice is present, and the interval between the starting position and the subsequent ending position of the human voice discriminated by the discriminator is extracted and output.

With this configuration, the amount of variation per unit time of sound power based on the sound data obtained by the microphone is detected by the amount-of-variation detector. Whether or not the amount of variation is greater than a predetermined value is checked by the point-of-variation detector, and if it is, a point of variation is stored. The number of points of variation within a predetermined discrimination period is monitored so that, if the number is greater than a previously set predetermined number, it is judged that human voice is present and, if less, it is judged that noise or silence is present. In this way, the starting position and ending position of each region of human voice are detected.

According to another embodiment of the invention, a sound playback device which performs playback of sound by retrieving sound data recorded on a recording medium is provided with a discriminator which discriminates between human voice and other than human voice. Here, the discriminator includes: an amount-of-variation detector which detects the amount of variation per unit time of sound power based on sound data; and a point-of-variation detector which detects the point of variation at which the amount of variation is greater than a predetermined value. Moreover, when the number of points of variation detected within a predetermined discrimination period is greater than a predetermined number, it is judged that human voice is present, and during playback, in response to a predetermined operation, a skip is made to a next starting position of the human voice discriminated by the discriminator.

With this configuration, the amount of variation per unit time of sound power based on the sound data obtained by the microphone is detected by the amount-of-variation detector. Whether or not the amount of variation is greater than a predetermined value is checked by the point-of-variation detector, and if it is, a point of variation is stored. The number of points of variation within a predetermined discrimination period is monitored so that, if the number is greater than a previously set predetermined number, it is judged that human voice is present and, if less, it is judged that noise or silence is present. In this way, the starting position of each region of human voice is detected; in response to a predetermined operation, a skip is made to the starting position of the next region of human voice, and this region is replayed.

According to another embodiment of the invention, a sound recording device is provided with: an amount-of-variation detector which detects the amount of variation per unit time of sound power based on sound data obtained by a microphone; and a point-of-variation detector which detects a point of variation at which the amount of variation is greater than a predetermined value. Here, when the number of points of variation detected within a predetermined discrimination period is greater than a predetermined number, recording is started.

With this configuration, when an instruction to start recording is entered, sound data is obtained by the microphone. The amount of variation per unit time of sound power based on the sound data obtained by the microphone is detected by the amount-of-variation detector. Whether or not the amount of variation is greater than a predetermined value is checked by the point-of-variation detector, and if it is, a point of variation is stored. The number of points of variation within a predetermined discrimination period is monitored so that, if the number is greater than a previously set predetermined number, it is judged that human voice is present, and recording is started.

According to one embodiment of the invention, in the sound recording device described above, when the sound power is lower than a predetermined value, the point-of-variation detector does not detect a point of variation. With this configuration, whether or not the sound power of the sound data obtained by the microphone is lower than a predetermined value is checked. If the sound power is lower than the predetermined value, even when the amount of variation of the sound power is great, it is ignored with regard to the detection of a point of variation.

According to another embodiment of the invention, in the sound recording device described above, there is further provided a FIFO memory which stores the sound data during the discrimination period. Here, when recording is started, the sound data on the FIFO memory is retrieved so that recording is performed retroactively to the beginning of the discrimination period.

With this configuration, when an instruction to start recording is entered, sound data obtained by the microphone is stored in the FIFO memory. When it is judged, by the amount-of-variation detector and the point-of-variation detector, that human voice is present within the discrimination period, the sound data is retrieved from the FIFO memory, and recording is performed. In this way, recording is performed retroactively to the beginning of the discrimination period, starting at the beginning of the human voice.

### Advantageous Effects of the Invention

With a sound recording/playback device according to the invention, there is no need for complicated operation to cut silence and noise, and this makes the sound recording/playback device more usable. Moreover, since human voice is discriminated during recording, no discrimination period is needed during playback, and this helps prevent delay in playback.

With a sound playback device according to the invention, it is possible to quickly extract and replay human voice. Thus, there is no need for complicated operation to cut silence and noise, and this makes the sound playback device more usable.

With a sound recording device according to the invention, when the number of points of variation within a discrimination period at which the amount of variation of sound power per unit time is greater than a predetermined value is greater than a predetermined number, it is judged that human voice is present, and recording is started. Thus, it is possible to quickly discriminate human voice, and this makes the sound recording device more usable.

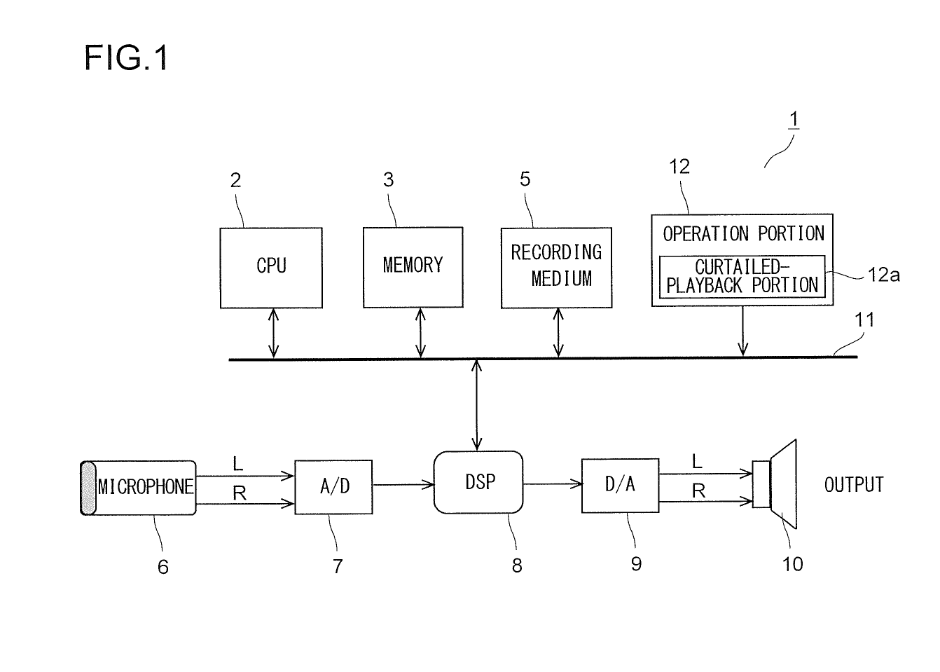

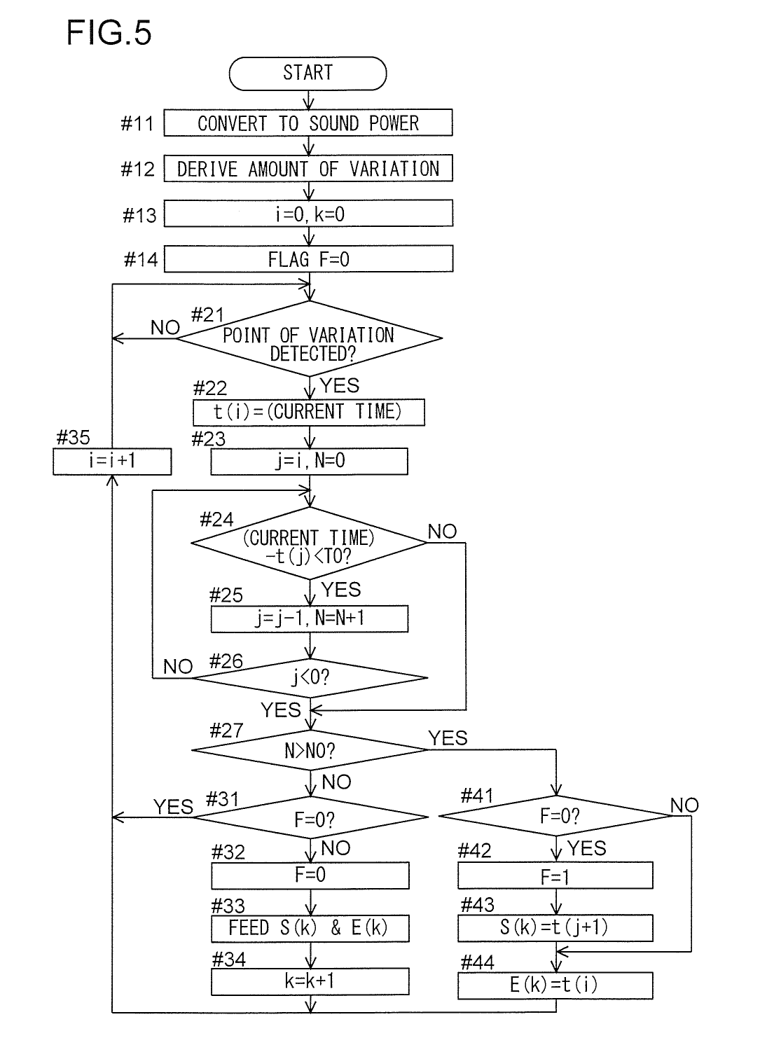

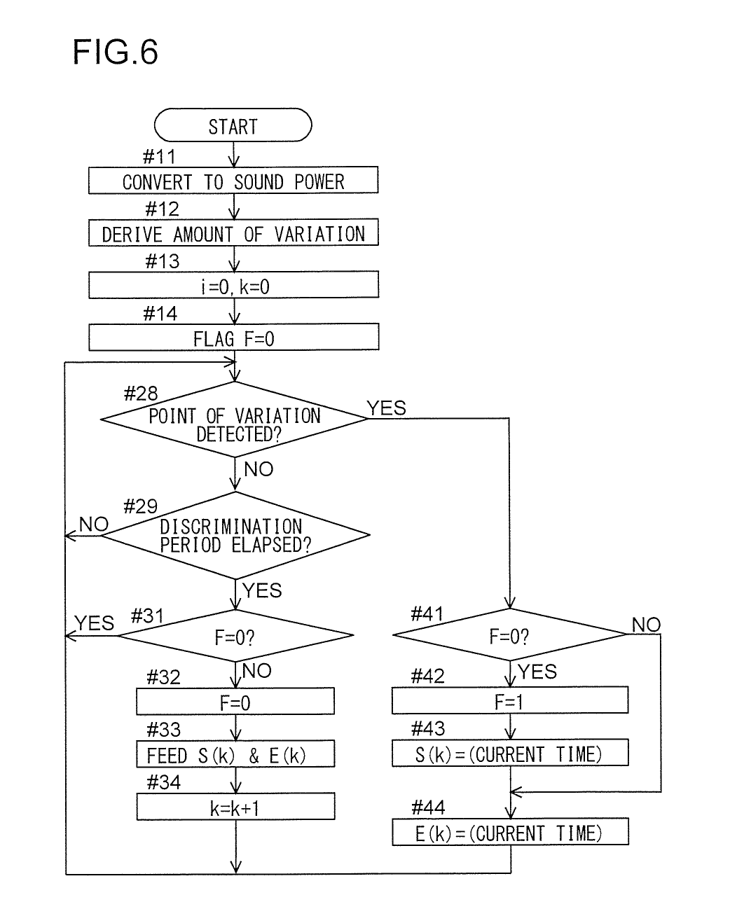

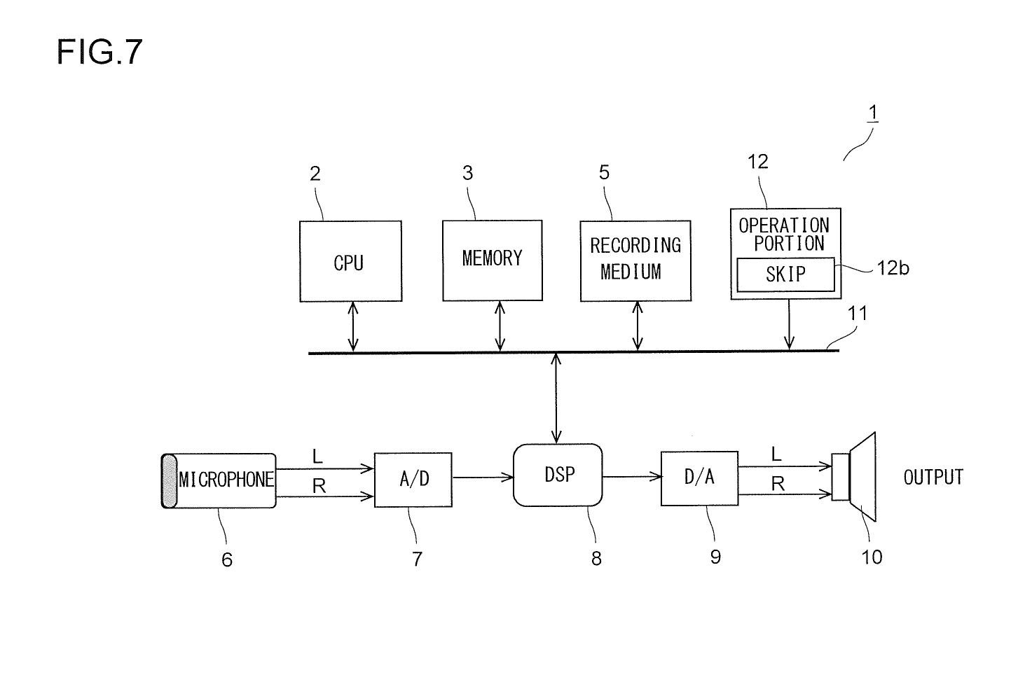

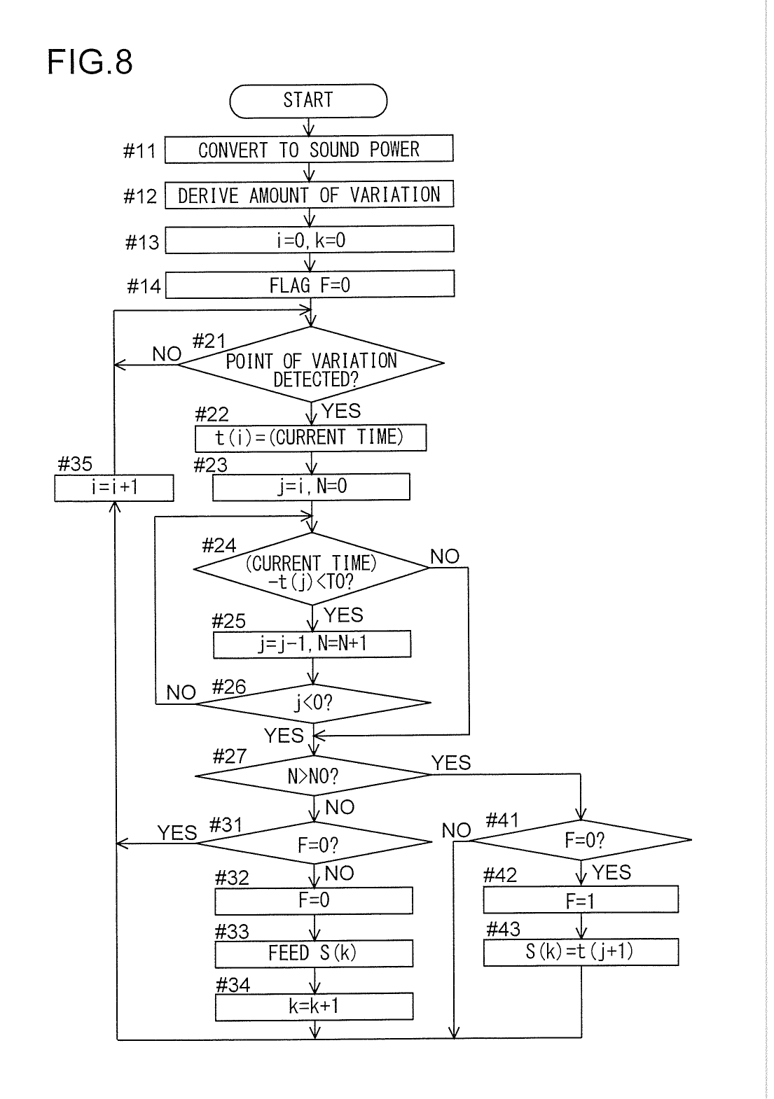

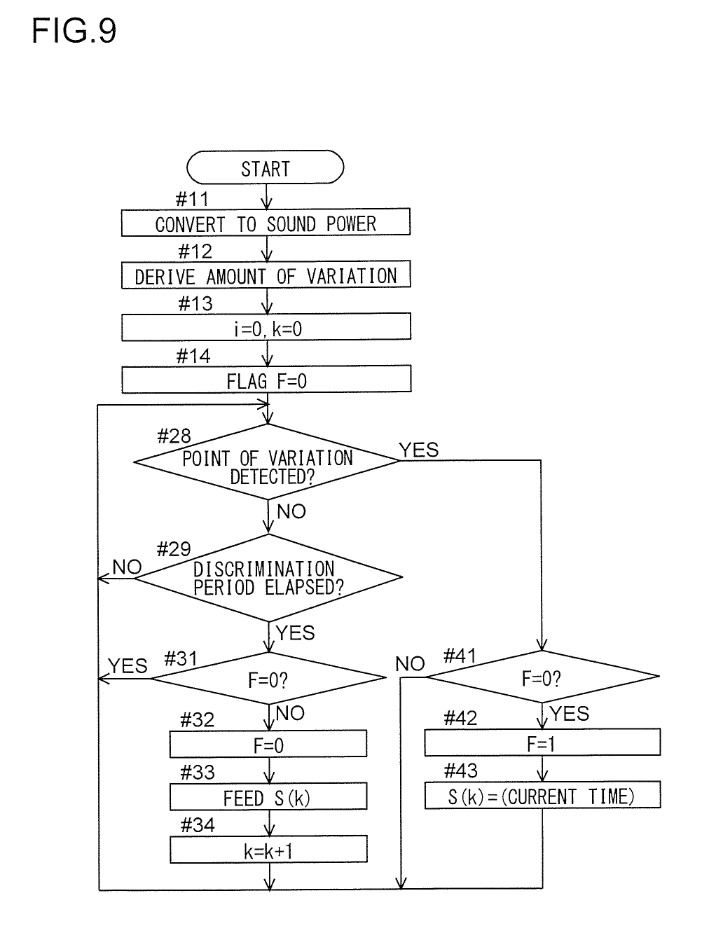

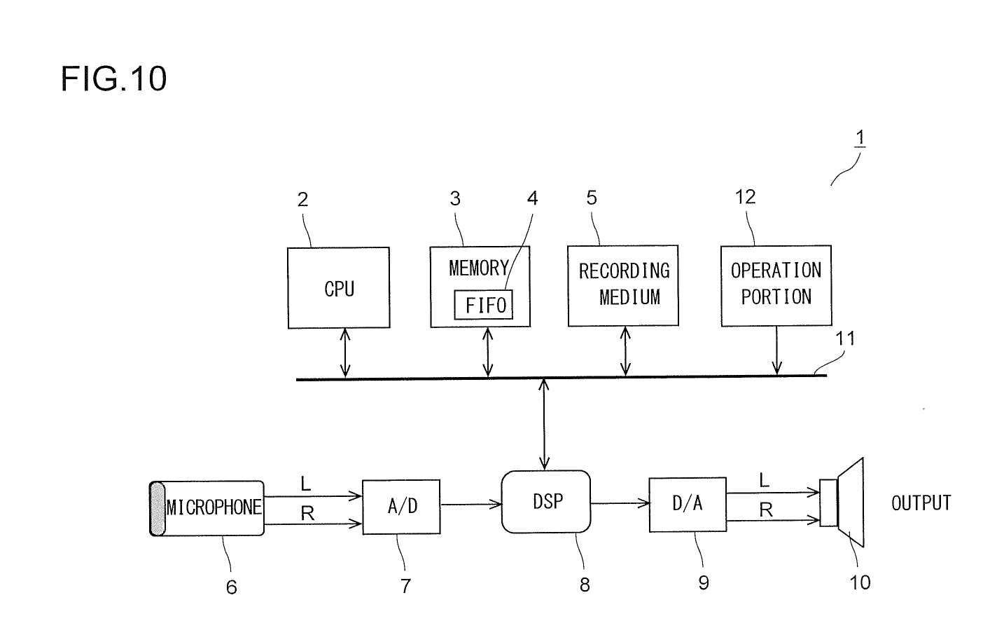

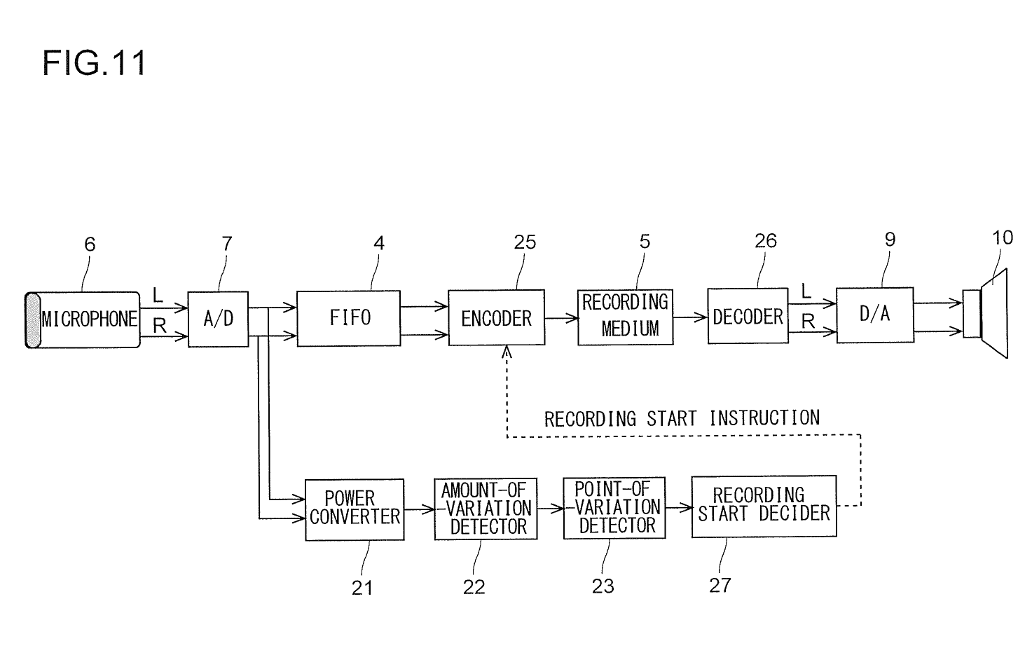

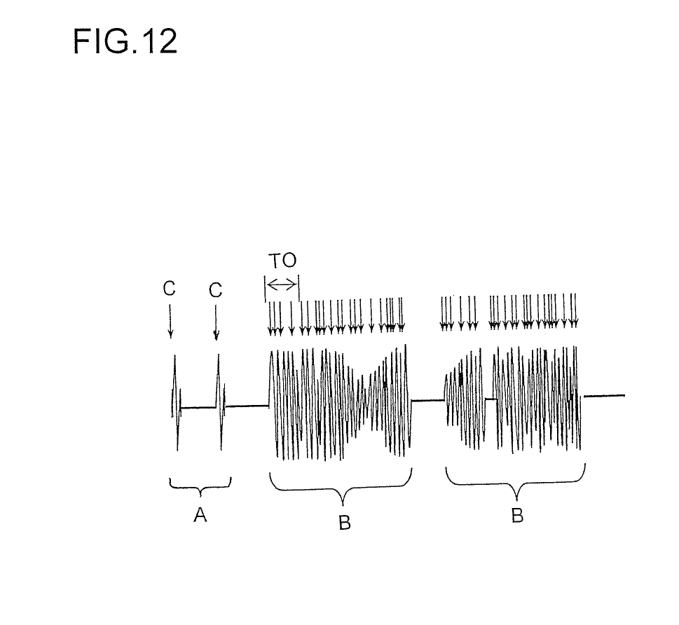

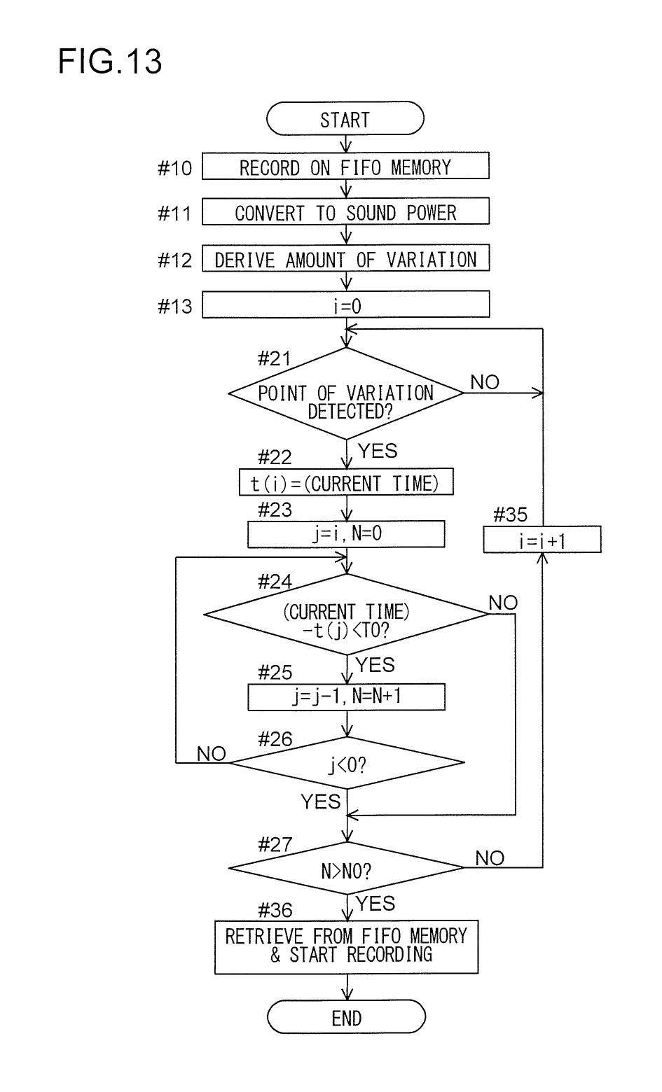

### BRIEF DESCRIPTION OF DRAWINGS

[FIG. 1] is a block diagram showing the configuration of a sound recording/playback device according to a first embodiment of the invention;

[FIG. 2] is a data flow diagram of the sound recording/playback device according to the first embodiment of the invention;

[FIG. 3] is a diagram showing an example of an analog audio signal obtained by a microphone in the sound recording/playback device according to the first embodiment of the invention;

[FIG. 4] is a diagram showing an example the amount of variation of sound power derived by an amount-of-variation detector in the sound recording/playback device according to the first embodiment of the invention;

[FIG. 5] is a flow chart showing the operation of the sound recording/playback device according to the first embodiment of the invention during recording;

[FIG. 6] is a flow chart showing the operation of a sound recording/playback device according to a second embodiment of the invention during recording;

[FIG. 7] is a block diagram showing the configuration of a sound recording/playback device according to a third embodiment of the invention;

[FIG. 8] is a flow chart showing the operation of the sound recording/playback device according to the third embodiment of the invention during recording;

[FIG. 9] is a flow chart showing the operation of a sound recording/playback device according to a fourth embodiment of the invention during recording;

[FIG. 10] is a block diagram showing the configuration of a sound recording/playback device according to a fifth embodiment of the invention;

[FIG. 11] is a data flow diagram of the sound recording/playback device according to the fifth embodiment of the invention;

[FIG. 12] is a diagram showing an example of an analog audio signal obtained by a microphone in the sound recording/playback device according to the fifth embodiment; and

[FIG. 13] is a flow chart showing the operation of the sound recording/playback device according to the fifth embodiment of the invention during processing for starting of recording.

### DESCRIPTION OF EMBODIMENTS

Hereinafter, embodiments of the present invention will be described with reference to the accompanying drawings. FIG. 1 is a block diagram showing the configuration of a sound recording/playback device according to a first embodiment of the invention. The sound recording/playback device 1 is provided with a microphone 6, which collects sound, and a loudspeaker 10, which outputs sound. An A/D (analog-to-digital) converter 7, which is connected to the microphone 6, converts an analog audio signal obtained by the microphone 6 to a digital audio signal.

To the A/D converter 7, a DSP (digital signal processor) 8 is connected, which performs various kinds of processing on sound data in the form of a digital audio signal output from the A/D converter 7. As will be described in detail later, a power converter 21, an amount-of-variation detector 22, a point-of-variation detector 23, and a speech detector 24 (for all these, see FIG. 2), which are provided in the DSP 8, perform processing for discriminating human voice from other than human voice. Moreover, an encoder 25 and a decoder 26 (for both, see FIG. 2), which are provided in the DSP 8, perform, as an audio codec, processing for compressing and decompressing sound data.

To the DSP 8, there are connected, via a bus line 11, a CPU 2, a memory 3, a recording medium 5, and an operation portion 12. The CPU 2 controls the DSP 8 and other blocks, and also performs calculations. The memory 3 provides temporary storage for the calculations by the CPU 2. The recording medium 5 is constituted by a flash memory, a magnetic recording medium, or the like, and records sound data in the form of a digital audio signal compressed by the DSP 8. The operation portion 12, by being operated by a user, issues instructions to start and stop recording and playback of sound. The operation portion 12 also issues, by means of a curtailed-playback portion 12a, an instruction to start curtailed playback.

The output side of the DSP 8 is connected via a D/A (digital-to-analog) converter 9 to the loudspeaker 10. The D/A converter 9 converts a non-compressed digital audio signal resulting from decoding of sound data on the recording medium 5 by the DSP 8 to an analog audio signal.

FIG. 2 is a data flow diagram of the sound recording/playback device 1. In response to an instruction to start recording from the operation portion 12, sound is collected by the microphone 6. FIG. 3 shows an example of sound data in the form of an analog audio signal obtained by the microphone 6. The sound data obtained by the microphone 6 includes a non-voice region A and a voice region B. The non-voice region A is a region of other than human voice, that is, a region of silence and noise such as sound of a desk being pounded or a chair being dragged. The voice region B is a region of human voice.

The sound data in the form of an analog audio signal is converted by the A/D converter 7, which outputs sound data in the form of a digital audio signal. The sound data output from the A/D converter 7 is fed to the power converter 21 and the encoder 25 in the DSP 8. The power converter 21 converts the digital sound data to sound power and outputs it to the amount-of-variation detector 22. The amount-of-variation detector 22 derives the amount of variation per unit time of the sound power, and data of the amount of variation is output to the point-of-variation detector 23.

FIG. 4 is a diagram showing an example of the amount of variation of the sound power derived by the amount-of-variation detector 22. In the diagram, the vertical axis represents the amount of variation of the sound power, and the horizontal axis represents time. The point-of-variation detector 23 detects, as a point of variation C, a point where the amount of variation of the sound power has a maximum greater than a predetermined value P0. Information on the time points at which points of variation C occur is output to the speech detector 24.

Based on the information on the time points of points of variation C, the speech detector 24 checks whether or not the number of points of variation C within a predetermined discrimination period T0 (see FIG. 3) is greater than a predetermined number. If the number of points of variation C within the predetermined discrimination period T0 is greater than the predetermined number, it is judged that human voice is present. If the number of points of variation C within the predetermined discrimination period T0 is equal to or less than the predetermined number, it is judged that a region of other than human voice is present. In this way, the starting position and ending position of each voice region B are detected. Thus, the power converter 21, the amount-of-variation detector 22, the point-of-variation detector 23, and the speech detector 24 together constitute a discriminator for discriminating between human voice and other than human voice in sound data.

On the other hand, the sound data fed to the encoder 25 is converted by the encoder 25 from a non-compressed digital audio signal to a compressed digital audio signal such as MP3. The compressed digital audio signal is, along with the data of the starting position and ending position of each voice region B detected by the speech detector 24, recorded on the recording medium 5.

In response to an instruction to replay from the operation portion 12, sound data in the form of a digital audio signal is retrieved from the recording medium 5, and is fed to the decoder 26 in the DSP 8. The compressed digital audio signal is converted by the decoder 26 to a non-compressed digital audio signal. The non-compressed digital audio signal is converted by the D/A converter 9 to an analog audio signal, which is output from the loudspeaker 10.

FIG. 5 is a flow chart showing in more detail the operation of the sound recording/playback device 1 during recording. In response to an instruction to record from the operation portion 12, at step #11, the power converter 21 converts sound data to sound power. At step #12, the amount-of-variation detector 22 derives the amount of variation of the sound power per unit time (for example, 260 msec) as shown in FIG. 4 described above.

Steps #13, #21, #22, and #35 involve operations performed by the point-of-variation detector 23. The operations at steps #13, #14, #23 through #34, and #41 through #44 involve operations performed by the speech detector 24. At step #13, a counter i (the point-of-variation detector 23) and a counter k (the speech detector 24) are initialized to 0.

At step #14, a flag F., which indicates a voice region B, is initialized to 0. At step #21, the point-of-variation detector 23 watches the amount of variation of the sound power and waits until a point of variation C is detected. When a point of variation C is detected, the flow proceeds to step #22, where the current time, at which the point of variation C is detected, is substituted in a variable t(i). As will be described later, steps #21 through #44 are repeated, and thus every time a point of variation C is detected, the time point of the point of variation C is stored in a variable, in the order t(0), t(1), t(2), and so forth (indicated by arrows in FIG. 3).

At step #23, the value of the counter i is substituted in a counter j, and a variable N, which counts points of variation C, is initialized to 0. At step #24, it is checked whether or not the time difference between the current time and the variable t(j) is shorter than the discrimination period T0.

If the time difference between the current time and the variable t(j) is not shorter than the discrimination period T0, the flow proceeds to step #27. If the time difference between the current time and the variable t(j) is shorter than the discrimination period T0, that is, if the time point of the variable t(j) is within the discrimination period T0 back from the current time, the flow proceeds to step #25.

At step #25, the counter j is decremented, and the variable N is incremented. At step #26, it is checked whether or not the counter j is less then 0. If the counter j is equal to or greater than 0, the flow returns to step #24. Thus, steps #24 through #26 are repeated as many times as there are variables t(j) within the discrimination period T0 back from the current time, and accordingly the variable N equals the number of points of variation C. If, at an early stage after the start of the processing, the counter j becomes less than 0 before the lapse of the discrimination period T0 back from the current time, there is no data for any t(j), and therefore the flow proceeds to step #27.

At step #27, it is checked whether or not the variable N is greater than a predetermined number N0. If the variable N is equal to or less than the predetermined number N0, there are few points of variation C within the discrimination period T0; thus, it is judged that a non-voice region A is present, and the flow proceeds to step #31. If the variable N is greater than the predetermined number N0, that is, if it is detected that there are a greater number of points of variation C than the predetermined number N0 within the discrimination period T0, it is judged that a voice region B is present, and the flow proceeds to step #41.

At step #41, it is checked whether or not the flag F equals 0. If the flag F equals 0, a non-voice region A has just ended, and a voice region B has now started; accordingly, at step #42, 1 is substituted in the flag F. At step #43, the value of the variable t(j+1), which indicates the time point of the first point of variation C within the discrimination period T0, is substituted in a variable S(k), which indicates the time point of the starting position of a voice region B. At step #44, the value of the variable t(i), which indicates the time point of the last point of variation C within the discrimination period T0, is substituted in a variable E(k), which indicates the time point of the ending position of a voice region B.

If the check at step #41 finds the flag F to be equal to 1, a voice region B continues to be present; thus, the flow proceeds to step #44, where the variable E(k), which indicates the time point of the ending position of a voice region B, is updated Then, at step #35, the counter i is incremented, and the flow returns to step #21.

If, at step #27, it is judged that a non-voice region A is present, then, at step #31, it is checked whether or not the flag F equals 0. If the flag F equals 0, a non-voice region A continues to be present; thus, at step #35, the counter i is incremented, and the flow returns to step #21. In this way, steps #21 through #31 are repeated, so that, every time a point of variation C is detected, data of the variable t(i) is accumulated, and thereby the number of points of variation C within the discrimination period T0 is detected.

If, at step #31, the flag F equals 1, it is judged that a change has occurred from a voice region B to a non-voice region A, and the flow proceeds to step #32. At step #32, 0 is substituted in the flag F. At step #33, the variables S(k) and E(k), which indicate the starting position and ending position of the voice region B, are fed to the recording medium 5, where it is recorded along with sound data. At step #34, the counter k is incremented, and the flow returns via step #35 to step #21. In this way, the staring position and ending position of the next voice region B are detected. When an operation to stop recording is made on the operation portion 12, recording is stopped.

When an operation to start normal playback is made, sound data is retrieved from the recording medium 5, and playback is performed. When the curtailed-playback portion 12a is operated, sound data is, along with time data of the starting position and ending position of voice regions B, retrieved from the recording medium 5. Then, the starting position (S(0)) of the first voice region B is detected, and playback is started; when a subsequent ending position (E(0)) is detected, playback is suspended. Likewise, the starting position and ending position of the second and following voice regions B are sequentially extracted and output.

According to this embodiment, a discriminator (the power converter 21, the amount-of-variation detector 22, the point-of-variation detector 23, and the speech detector 24) for discriminating between a voice region B, which is a region of human voice, and a non-voice region A, which is a region of other than human voice, records the starting position S(k) and ending position E(k) of the voice region B during recording so that, during curtailed playback, the interval between the starting position and ending position is extracted and replayed. This eliminates the need for complicated operation to cut silence and noise, and thus makes the sound recording/playback device 1 more usable.

Moreover, when the number of points of variation C within a discrimination period T0 at which the amount of variation of sound power per unit time is greater than a predetermined value P0 is greater than a predetermined number N0, it is judged that human voice is present. This permits easier and quicker discrimination of human voice than by frequency decomposition or the like of sound data within the discrimination period T0.

At step #21, when the sound power is lower than a predetermined value, the detection of a point of variation C may be omitted. In this way, even when the amount of variation of the sound power is great, if the sound volume is low, it is judged that a non-voice region A is present. This helps suppress unnecessary consumption of the memory 3, which stores the variable t(i).

FIG. 6 is a flow chart showing the operation of a sound recording/playback device 1 according to a second embodiment of the invention during recording. In this embodiment, the method of discriminating between a non-voice region A and a voice region B differs from that in the first embodiment. In the diagram, the steps #11 through 14 and #31 through #44 are similar to those in FIG. 5 described above, and accordingly overlapping description will be partly omitted.

At step #28, the point-of-variation detector 23 watches the amount of variation of the sound power, and it is checked whether or not a point of variation C is detected. If no point of variation C is detected, the flow proceeds to step #29, where it is checked whether or not a discrimination period T0 has elapsed. If the discrimination period T0 has not elapsed yet, the flow returns to step #28, so that steps #28 and #29 are repeated.

If a point of variation C is detected within the discrimination period T0, it is judged that a voice region B has started, and the flow proceeds to step #41. The steps #41 through #44 are similar to those in the first embodiment. It should however be noted that, at steps #43 and #44, the current time is substituted in the variables S(k) and E(k), which indicate the time points of the starting position and ending position of a voice region B.

If no point of variation C is detected within the discrimination period T0, it is judged that a non-voice region A has started, and the flow proceeds to step #31. Steps #31 through #34 are similar to those in the first embodiment.

In this embodiment, as in the first embodiment, the starting position S(k) and ending position E(k) of a voice region B are recorded during recording so that the interval between the starting position and ending position is extracted and replayed. This eliminates the need for complicated operation to cut silence and noise, and thus makes the sound recording/playback device 1 more usable.

Moreover, when any point of variation C is detected within the discrimination period T0, it is judged that human voice is present. This helps reduce the capacity of the memory 3, which stores the variable t(i) (see FIG. 5).

FIG. 7 is a block diagram of the configuration of a sound recording/playback device according to a third embodiment of the invention. For convenience's sake, such parts as find their counterparts in the first embodiment shown in FIGS. 1 and 2 described above are identified by the same reference signs. In this embodiment, in place of the curtailed-playback portion 12a (see FIG. 1), a skip button 12b is provided on the operation portion 12. The skip button 12b effects, during playback, a skip to the beginning of the next voice region B. In other respects, the configuration here is similar to that in first embodiment.

FIG. 8 is a flow chart showing the operation of the sound recording/playback device 1 during recording. Compared with the flow in the first embodiment shown in FIG. 5 described above, the operation at step #33 differs, and step #44 is omitted. In other respects, the flow is the same as in the first embodiment, and therefore no overlapping description will be repeated.

When, at step #32, 0 is substituted in the flag F, then, at step #33, the variable S(k), which indicates the starting position of a voice region B, is fed to the recording medium 5, where it is recorded along with sound data. At step #34, the counter k is incremented, and the flow returns via step #35 to step #21.

At step #41, it is checked whether or not the flag F equals 0. If the flag F equals 0, a non-voice region A has just ended and a voice region B has just started, and thus, at step #42, 1 is substituted in the flag F. At step #43, the value of the variable t(j+1), which indicates the time point of the first point of variation C within the discrimination period T0, is substituted in the variable S(k), which indicates the time point of the starting position of the voice region B. Then, at step #35, the counter i is incremented, and the flow returns to step #21. If the check at step #41 finds the flag F to be equal to 1, a voice region B continues to be present, and thus the flow, skipping steps #42 and #43, proceeds to step #35.

When an operation to perform ordinary playback is made, sound data is retrieved from the recording medium 5, and playback is performed. During playback, when the skip button 12b is operated, sound data is, along with time data of the starting position of a voice region B, retrieved from the recording medium 5. Then, a skip is made to the starting position (S(k)) of the next voice region B, and the voice region B is replayed.

In this embodiment, a discriminator (the power converter 21, the amount-of-variation detector 22, the point-of-variation detector 23, and the speech detector 24) for discriminating between a voice region B, which is a region of human voice, and a voice region B, which is a region of other than human voice, records the starting position S(k) of the voice region B during recording and, when the skip button 12b is operated, a skip is made to the starting position of the next voice region B, and playback is performed. This eliminates the need for complicated operation to cut silence and noise, and thus makes the sound recording/playback device 1 more usable.

Moreover, as in the first embodiment, when the number of points of variation C within a discrimination period T0 at which the amount of variation of sound power per unit time is greater than a predetermined value P0 is greater than a predetermined number N0, it is judged that human voice is present. This permits easier and quicker discrimination of human voice than by frequency decomposition or the like of sound data within the discrimination period T0.

At step #21, when the sound power is lower than a predetermined value, the detection of a point of variation C may be omitted. In this way, even when the amount of variation of the sound power is great, if the sound volume is low, it is judged that a non-voice region A is present. This helps suppress unnecessary consumption of the memory 3, which stores the variable t(i).

FIG. 9 is a flow chart showing the operation of a sound recording/playback device 1 according to a fourth embodiment of the invention. In this embodiment the method of discriminating between a non-voice region A and a voice region B differs from that in the third embodiment. In the diagram, steps #11 through #14 and #31 through #44 are similar to those in FIG. 8 described above, and therefore overlapping description will be partly omitted.

At step #28, the point-of-variation detector 23 watches the amount of variation of the sound power, and it is judged whether or not a point of variation C is detected. If no point of variation C is detected, the flow proceeds to step #29, where it is judged whether or not a discrimination period T0 has elapsed. If the discrimination period T0 has not elapsed yet, the flow returns to step #28, so that steps #28 and #29 are repeated.

If a point of variation C is detected within the discrimination period T0, it is judged that a voice region B has started, and the flow proceeds to step #41. Steps #41 through #43 are similar to those in the third embodiment. It should however be noted that the current time is substituted in the variable S(k), which indicates the time point of the starting position of the voice region B.

If no point of variation C is detected within the discrimination period T0, it is judged that a non-voice region A has started, and the flow proceeds to step #31. Steps #31 through #34 are similar to those in the third embodiment.

In this embodiment, as in the third embodiment, the starting position S(k) of a voice region B is recorded during recording and, when the skip button 12b is operated, a skip is made to the next voice region B, and playback is performed. This eliminates the need for complicated operation to cut silence and noise, and thus makes the sound recording/playback device 1 more usable.

Moreover, when any point of variation C is detected within the discrimination period T0, it is judged that a voice region B is present, and this helps reduce the capacity of the memory 3, which stores the variable t(i) (see FIG. 8).

In the first to fourth embodiments, the operation for discriminating between a non-voice region A and a voice region B shown in FIGS. 5, 6, 8, and 9 may be performed during playback. In that case, when the number of points of variation C within the discrimination period T0 at which the amount of variation of the sound power per unit time is greater than the predetermined value P0 is greater than the predetermined number N0, it is judged that human voice is present. This permits easier and quicker discrimination of human voice than by frequency decomposition or the like of sound data within the discrimination period T0, and thus helps prevent delay in playback.

When human voice is discriminated during recording as in the first to fourth embodiments, no discrimination period is needed during playback, and this helps prevent delay in playback more reliably.

Although the sound recording/playback device 1 both records and replays sound, the recording capability may be omitted so that it only replays sound. In that case, the above-described operation for discriminating between a non-voice region A and a voice region B may be performed during playback, and this makes the sound playback device more usable.

FIGS. 10 and 11 are a block diagram and a data flow diagram showing the configuration of a sound recording/playback device according to a fifth embodiment of the invention. For convenience' sake, such parts as find their counterparts in the first embodiment shown in FIGS. 1 to 5 described above are identified by the same reference signs. This embodiment differs from the first embodiment in the following respects. A FIFO (first-in/first-out) memory 4 is formed in the memory 3. The FIFO memory 4 sequentially stores sound data in the form of a digital audio signal output from the A/D converter 7, and thereby stores a prescribed amount of sound data.

Moreover, the curtailed-playback portion 12a (see FIG. 1) in the operation portion 12 is omitted, and in place of the speech detector 24 (see FIG. 2), a recording start decider 27 is provided. In other respect, the configuration is similar to that in the first embodiment.

In response to an instruction to start recording from the operation portion 12, sound is collected by the microphone 6. FIG. 12 shows an example of sound data in the form of an analog audio signal obtained by the microphone 6. The sound data obtained by the microphone 6 includes a non-voice region A, which is a region of noise such as sound of a desk being pounded or a chair being dragged, and a voice region B, which is a region of human voice. The sound data in the form of an analog audio signal is converted by the A/D converter 7, which outputs sound data in the form of a digital audio signal. The sound data output from the A/D converter 7 is accumulated on the FIFO memory 4, and is also fed to the power converter 21 in the DSP 8.

The power converter 21 converts the digital sound data to sound power and outputs it to the amount-of-variation detector 22. The amount-of-variation detector 22 derives the amount of variation per unit time of the sound power, and data of the amount of variation is output to the point-of-variation detector 23.

As shown in FIG. 4 described above, the point-of-variation detector 23 detects, as a point of variation C, a point where the amount of variation of the sound power has a maximum greater than a predetermined value P0. Information on the time points at which points of variation C occur is output to the recording start decider 27.

Based on the information on the time points of points of variation C, the recording start decider 27 checks whether or not the number of points of variation C within a predetermined discrimination period T0 (see FIG. 12) is greater than a predetermined number. If the number of points of variation C within the predetermined discrimination period T0 is greater than the predetermined number, it is judged that human voice is present, and an instruction to start recording is issued. In this way, the power converter 21, the amount-of-variation detector 22, the point-of-variation detector 23, and the recording start decider 27 can discriminate human voice in sound data.

On the other hand, in response to the instruction to start recording from the recording start decider 27, the sound data accumulated on the FIFO memory 4 is fed to the encoder 25 in the DSP 8. It is converted by the encoder 25 from a non-compressed digital audio signal to a compressed digital audio signal such as MP3. The compressed digital audio signal is recorded on the recording medium 5.

In response to an instruction to replay from the operation portion 12, sound data in the form of a digital audio signal is retrieved from the recording medium 5, and is fed to the decoder 26 in the DSP 8. The compressed digital audio signal is converted by the decoder 26 to a non-compressed digital audio signal. The non-compressed digital audio signal is converted by the D/A converter 9 to an analog audio signal, which is output from the loudspeaker 10.

FIG. 13 is a flow chart showing in more detail the operation of the sound recording/playback device 1 during recording. Steps #11 through #13 and #21 through #35 are similar to those in the first embodiment shown in FIG. 5 described above. In response to an instruction to record from the operation portion 12, at step #10, sound data is accumulated on the FIFO memory 4. At step #11, the power converter 21 converts the sound data to sound power. At step #12, the amount-of-variation detector 22 derives the amount of variation of the sound power per unit time (for example, 260 msec) as shown in FIG. 4 described above.

Steps #13, #21, #22, and #35 involve operations performed by the point-of-variation detector 23. At step #13, a counter i is initialized to 0. At step #21, the point-of-variation detector 23 watches the amount of variation of the sound power and waits until a point of variation C is detected. When a point of variation C is detected, the flow proceeds to step #22, where the current time, at which the point of variation C is detected, is substituted in a variable t(i). Steps #21 through #35 are repeated, and thus every time a point of variation C is detected, the time point of the point of variation C is stored in a variable, in the order t(0), t(1), t(2), and so forth (indicated by arrows in FIG. 12).

Steps #23 through #27 involve operations performed by the recording start decider 27. At step #23, the value of the counter i is substituted in a counter j, and a variable N, which counts points of variation C, is initialized to 0. At step #24, it is checked whether or not the time difference between the current time and the variable t(j) is shorter than the discrimination period T0.

If the time difference between the current time and the variable t(j) is not shorter than the discrimination period T0, the flow proceeds to step #27. If the time difference between the current time and the variable t(j) is shorter than the discrimination period T0, that is, if the time point of the variable t(j) is within the discrimination period T0 back from the current time, the flow proceeds to step #25.

At step #25, the counter j is decremented, and the variable N is incremented. At step #26, it is checked whether or not the counter j is less then 0. If the counter j is equal to or greater than 0, the flow returns to step #24. Thus, steps #24 through #26 are repeated as many times as there are variables t(j) within the discrimination period T0 back from the current time, and accordingly the variable N equals the number of points of variation C. If, at an early stage after the start of the processing, the counter j becomes less than 0 before the lapse of the discrimination period T0 back from the current time, there is no data for any t(j), and therefore the flow proceeds to step #27.

At step #27, it is checked whether or not the variable N is greater than a predetermined number N0. If the variable N is equal to or less than the predetermined number N0, there are few points of variation C within the discrimination period T0; thus, it is judged that a non-voice region A is present. Then, at step #35, the counter i is incremented, and the flow returns to step #21. In this way, steps #21 through #35 are repeated, so that, every time a point of variation C is detected, data of the variable t(i) is accumulated, and thereby the number of points of variation C within the discrimination period T0 is detected.

If the variable N is greater than the predetermined number N0, that is, if it is detected that there are a greater number of points of variation C than the predetermined number N0 within the discrimination period T0, it is judged that a voice region B is present, and the flow proceeds to step #36. At step #36, the DSP 8 retrieves sound data from the FIFO memory 4, the encoder 25 compresses the sound data, and recording is started. In this way, recording is performed retroactively to the beginning of the discrimination period T0. When an operation to stop recording is made on the operation portion 12, recording is stopped.

In this embodiment, when the number of points of variation C within a discrimination period T0 at which the amount of variation of sound power per unit time is greater than a predetermined value P0 is greater than a predetermined number N0, it is judged that a voice region B is present, and recording is started. Thus, it is possible to quickly discriminate a voice region B. This helps reduce the capacity of the FIFO memory 4, and thus helps reduce the cost of the sound recording/playback device 1 (sound recording device).

Moreover, when recording is started, sound data on the FIFO memory 4 is retrieved so that recording is performed retroactively to the beginning of the discrimination period T0. Thus, it is possible to record human voice from the beginning. This make the sound recording/playback device 1 more usable.

Recording may be performed without the provision of the FIFO memory 4. In that case, recording does not take place for the discrimination period T0 after human voice starts to be collected; even so, it is possible to quickly discriminate a voice region B, and thus to shorten the discrimination period T0 (for example, one second). This helps quickly start recording, and thus makes the sound recording/playback device 1 more usable.

At step #21, when the sound power is lower than a predetermined value, the detection of a point of variation C may be omitted. In this way, even when the amount of variation of the sound power is great, if the sound volume is low, it is judged that a non-voice region A is present. This helps suppress unnecessary consumption of the memory 3, which stores the variable t(i).

In this embodiment, although the sound recording/playback device 1 both records and replays sound, the recording capability may be omitted so that it only replays sound.

### INDUSTRIAL APPLICABILITY

The present invention finds applications in sound recording/playback devices, such as voice recorders, for recording sound on, and replaying sound from, a recording medium. The invention also finds applications in sound playback devices for replaying sound recorded on a recording medium. The invention also finds applications in sound recording devices, such as voice recorders, for recording sound on a recording medium.

### LIST OF REFERENCE SIGNS

1 sound recording/playback device

2 CPU

3 memory

4 FIFO memory

5 recording medium

6 microphone

7 A/D converter

8 DSP

9 D/A converter

10 loudspeaker

11 bus line

12 operation portion

12a curtailed-playback portion

12b skip button

21 power converter

22 amount-of-variation detector

23 point-of-variation detector

24 speech detector

25 encoder

26 decoder

27 recording start decider

1. A sound recording/playback device which performs recording by recording sound data obtained by a microphone on a recording medium and which performs playback by retrieving sound data from the recording medium, the sound recording/playback device comprising:
a discriminator which discriminates between human voice and other than human voice,
wherein
during recording, a starting position and an ending position of the human voice discriminated by the discriminator are recorded, and
during playback, an interval between the starting position and the subsequent ending position is extracted and output.

2. A sound recording/playback device which performs recording by recording sound data obtained by a microphone on a recording medium and which performs playback by retrieving sound data from the recording medium, the sound recording/playback device comprising:
a discriminator which discriminates between human voice and other than human voice,
wherein
during recording, a starting position of the human voice discriminated by the discriminator is recorded, and
during playback, in response to a predetermined operation, a skip is made to the next starting position.

3. The sound recording/playback device according to claim 1,
wherein the discriminator comprises:
an amount-of-variation detector which detects an amount of variation per unit time of sound power based on the sound data obtained by the microphone; and
a point-of-variation detector which detects a point of variation at which the amount of variation is greater than a predetermined value, and
when a number of points of variation detected within a predetermined discrimination period is greater than a predetermined number, it is judged that human voice is present.

4. The sound recording/playback device according to claim 3,
wherein, when the sound power is lower than a predetermined value, the point-of-variation detector does not detect a point of variation.

5. The sound recording/playback device according to claim 1,
wherein the discriminator comprises:
an amount-of-variation detector which detects an amount of variation per unit time of sound power based on the sound data obtained by the microphone; and
a point-of-variation detector which detects a point of variation at which the amount of variation is greater than a predetermined value, and
when the point of variation is detected within a predetermined discrimination period, it is judged that human voice is present.

6. The sound recording/playback device according to claim 5,
wherein, when the sound power is lower than a predetermined value, the point-of-variation detector does not detect a point of variation.

7. A sound playback device which performs playback of sound by retrieving sound data recorded on a recording medium, the sound playback device comprising:
a discriminator which discriminates between human voice and other than human voice,
wherein
the discriminator comprises:
an amount-of-variation detector which detects an amount of variation per unit time of sound power based on sound data; and
a point-of-variation detector which detects a point of variation at which the amount of variation is greater than a predetermined value,
when a number of points of variation detected within a predetermined discrimination period is greater than a predetermined number, it is judged that human voice is present, and
an interval between a starting position and a subsequent ending position of the human voice discriminated by the discriminator is extracted and output.

8. A sound playback device which performs playback of sound by retrieving sound data recorded on a recording medium, the sound playback device comprising:
a discriminator which discriminates between human voice and other than human voice,
wherein
the discriminator comprises:
an amount-of-variation detector which detects an amount of variation per unit time of sound power based on sound data; and
a point-of-variation detector which detects a point of variation at which the amount of variation is greater than a predetermined value,
when a number of points of variation detected within a predetermined discrimination period is greater than a predetermined number, it is judged that human voice is present, and
during playback, in response to a predetermined operation, a skip is made to a next starting position of the human voice discriminated by the discriminator.

9. A sound recording device comprising:
an amount-of-variation detector which detects an amount of variation per unit time of sound power based on sound data obtained by a microphone; and
a point-of-variation detector which detects a point of variation at which the amount of variation is greater than a predetermined value,
wherein
when a number of points of variation detected within a predetermined discrimination period is greater than a predetermined number, recording is started.

10. The sound recording device according to claim 9,
wherein, when the sound power is lower than a predetermined value, the point-of-variation detector does not detect a point of variation.

11. The sound recording device according to claim 9, further comprising:
a FIFO memory which stores the sound data during the discrimination period,
wherein
when recording is started, the sound data on the FIFO memory is retrieved so that recording is performed retroactively to the beginning of the discrimination period.

12. The sound recording/playback device according to claim 2,
wherein the discriminator comprises:
an amount-of-variation detector which detects an amount of variation per unit time of sound power based on the sound data obtained by the microphone; and
a point-of-variation detector which detects a point of variation at which the amount of variation is greater than a predetermined value, and
when a number of points of variation detected within a predetermined discrimination period is greater than a predetermined number, it is judged that human voice is present.

13. The sound recording/playback device according to claim 2,
wherein the discriminator comprises:
an amount-of-variation detector which detects an amount of variation per unit time of sound power based on the sound data obtained by the microphone; and
a point-of-variation detector which detects a point of variation at which the amount of variation is greater than a predetermined value, and
when the point of variation is detected within a predetermined discrimination period, it is judged that human voice is present.

14. The sound recording device according to claim 10, further comprising:
a FIFO memory which stores the sound data during the discrimination period,
wherein
when recording is started, the sound data on the FIFO memory is retrieved so that recording is performed retroactively to the beginning of the discrimination period.
